(19) United States
(12) Patent Application Publication
(10) Pub. No.: US 2023/0141621 A1
(43) Pub. Date: May 11, 2023

(54) METHOD FOR PROVIDING BATTLE ROYALE GAME WHICH ALLOWS PLAYERS TO SEARCH FOR SUB ITEMS USED FOR UPGRADING OR REPAIRING MAIN ITEMS AND GAME SERVER USING THE SAME

(71) Applicant: Wonder People Co., Ltd., Seoul (KR)

(72) Inventor: Min HUR, Seoul (KR)

(21) Appl. No.: 17/979,812

(22) Filed: Nov. 3, 2022

(30) Foreign Application Priority Data
Nov. 9, 2021 (KR) 10-2021-0152777
Jun. 16, 2022 (KR) 10-2022-0073832

(51) Int. Cl. A63F 13/5372; A63F 13/80; A63F 13/44

(52) U.S. Cl. CPC A63F 13/5372; A63F 13/80; A63F 13/44

(57) ABSTRACT

A battle royale game is provided to allow players to search for sub items used for upgrading or repairing main items. A method for providing the battle royale game includes: (a) in response to acquiring an item search request containing item information and location information of a player, determining whether specific sub item corresponding to the item information is located within a search target area; and (b) in response to detecting that the specific sub item is located within the search target area, displaying a location-indicating marker corresponding to the specific sub item through at least part of a 1-st display area for displaying azimuth information, a 2-nd display area for displaying the location information of the player in the field; and a 3-rd display area for displaying the location information of the player in the map.

### CROSS REFERENCE OF RELATED APPLICATION

This application claims the benefit of priority to Korean Provisional Patent Application No. 10-2021-0152777, filed on Nov. 9, 2021 and Korean Patent Application No. 10-2022-0073832, filed on Jun. 16, 2022, the entire contents of which being incorporated herein by reference.

### FIELD OF THE DISCLOSURE

The present disclosure relates to a method for providing a battle royale game and a server using the same; and more particularly, to the method for providing the battle royale game which allows players to search for sub items used for upgrading or repairing main items, and the server using the same.

### BACKGROUND OF THE DISCLOSURE

Players participating in conventional battle royale games were unable to produce new items by combining items (for example, weapons, protective items, bags, healing items, material items, etc.) spawned in a battle-possible area (i.e., a so-called battle field).

For example, in a conventional battle royale game, user experience of additionally equipping a sight subsystem or a handle, etc. on a gun was merely provided, and the user experience of upgrading the item itself such as a gun, etc. was not provided.

Accordingly, conventionally, the players had to play through a simple manner of participating in the battle by using the items such as weapons/protective items spawned in the field in the acquired states as they are.

However, due to the repetition of such a simple manner of play, the users easily lost interests in the battle royale games and accordingly, there was a problem that the lifespan of the battle royale game which has cost astronomical money for development quickly shortened.

Therefore, an enhanced method for solving the aforementioned problems is required.

### SUMMARY OF THE DISCLOSURE

It is an object of the present disclosure to solve all the aforementioned problems.

It is another object of the present disclosure to support players participating in a battle royale game to be capable of easily upgrading or repairing main items.

It is still another object of the present disclosure to automatically search sub items used in upgrading or repairing of main items.

It is still yet another object of the present disclosure to support the players to easily acquire the sub items by displaying one or more location-indicating markers corresponding to the sub items.

It is still yet another object of the present disclosure to induce battles among the players participating in the battle royale game, thereby preventing the users controlling the players of the battle royale game from losing interest easily.

In accordance with one aspect of the present disclosure, there is provided a method for providing a battle royale game which allows players to search for sub items used for upgrading or repairing main items, including steps of: (a) in response to acquiring an item search request containing (i) item information related to at least part of main item information on at least one main item corresponding to a player and sub item information related to at least one sub item corresponding to a player, and (ii) location information of the player in a field, wherein the sub item is an item to be used for upgrading the main item or for repairing the main item, a game server determining or supporting another device to determine whether at least one specific sub item corresponding to the item information is located within a search target area determined based on a specific location corresponding to the location information of the player in the field, by referring to the item search request; and (b) in response to detecting that the specific sub item is located within the search target area determined based on the specific location, the game server displaying or supporting another device to display a location-indicating marker corresponding to the specific sub item through at least part of (i) a 1-st display area for displaying azimuth information, (ii) a 2-nd display area for displaying the location information of the player in the field; and (iii) a 3-rd display area for displaying the location information of the player in the map.

As one example, there is provided a method, wherein, at the step of (a), the game server detects whether the specific sub item corresponding to the item information is located in a 1-st search target area determined based on a 1-st specific location corresponding to the location information of the player in the field by referring to the item search request, and wherein, at the step of (b), in response to detecting that the specific sub item is not located in the 1-st search target area determined based on the 1-st specific location, the game server determines whether the specific sub item corresponding to the item information is located in a 2-nd search target area determined based on a 2-nd specific location by referring to information on the 2-nd specific location of the player acquired after a time for re-detection has elapsed, and in response to determining that the specific sub item is located in the 2-nd search target area determined based on the 2-nd specific location, displaying the location-indicating marker corresponding to the specific sub item through at least part of the 1-st display area, the 2-nd display area and the 3-rd display area.

As one example, there is provided a method, further including a step of: (c) in response to satisfying a specific condition which is one of (i) a 1-st condition that a preset marker exposure time elapsed from a specific timing when the location-indicating marker is displayed through at least part of the 1-st display area, the 2-nd display area and the 3-rd display area, (ii) a 2-nd condition that the specific sub item is acquired by the player in the marker exposure time from the specific timing; and (iii) a 3-rd condition that the specific sub item is acquired by another player in the marker exposure time from the specific timing and that the player moves to an item-adjacent region determined based on a location of the specific sub item in the marker exposure time from the specific timing, the game server blocking the location-indicating marker corresponding to the specific sub item which has been displayed through at least part of the 1-st display area, the 2-nd display area and the 3-rd display area.

As one example, there is provided a method, on condition that information on each of a 1-st main item to an m-th main item, 1-st hierarchy information among at least one 1-st sub item corresponding to the 1-st main item to m-th hierarchy information among at least one m-th sub item corresponding to the m-th main item have been stored and managed in a fixed-value database, wherein, at the step of (a), spawned location information representing a location where at least part of the 1-st sub item to the m-th sub item is spawned in the field is stored and managed in a variable-value database, wherein, at the step of (b), in response to determining that the specific sub item is located in the search target area, the game server performs at least part of (i) a process of displaying at least one 1-st location-indicating marker in a 1-st mapping location matching with a direction which the player is currently looking at in the 1-st display area for displaying the azimuth information in a bar form, (ii) a process of displaying at least one 2-nd location-indicating marker in a 2-nd mapping location matching with a location of the specific sub item in the field in the 2-nd display area for displaying the location information in the field; and (iii) a process of displaying at least one 3-rd location-indicating marker in a 3-rd mapping location matching with a location of the specific sub item on the map in the 3-rd display area for displaying the location information on the map.

As one example, there is provided a method, wherein, at the step of (b), the game server displays at least part of a specific 1-st location-indicating marker, a specific 2-nd location-indicating marker and a specific 3-rd location-indicating marker corresponding to a selected sub item for upgrading a selected main item among the specific sub item or repairing the selected main item by highlighting the specific 1-st location-indicating marker, the specific 2-nd location-indicating marker and the specific 3-rd location-indicating marker through at least part of the 1-st display area, the 2-nd display area and the 3-rd display area, and wherein the selected main item is an item selected by the player or the game server among the main item.

As one example, there is provided a method, wherein, at the step of (b), the game server displays at least part of the specific 1-st location-indicating marker, the specific 2-nd location-indicating marker and the specific 3-rd location-indicating marker by highlighting the specific 1-st location-indicating marker, the specific 2-nd location-indicating marker and the specific 3-rd location-indicating marker through at least part of the 1-st display area, the 2-nd display area and the 3-rd display area, and wherein the game server (1) detects a specific necessity-degree, corresponding to the selected sub item, defined by a predetermined function having arguments of at least part of (i) information on whether at least one another player located in another player-related reference area determined based on the specific location of the player has selected the selected main item, (ii) information on a distance between the at least one another player and the selected sub item, and (iii) information on a velocity of the at least one another player approaching a location of the selected sub item, and (2) displays at least part of the specific 1-st location-indicating marker, the specific 2-nd location-indicating marker and the specific 3-rd location-indicating marker to correspond to the specific necessity-degree.

As one example, there is provided a method, wherein, at the step of (a), in response to acquiring the item search request containing k-th main item information on a k-th main item among the 1-st main item to the m-th main item, k-th sub item information on at least one k-th sub item corresponding to the k-th main item, and the location information of the player in the field and the direction information of the player in the field, the game server (i) transmits a (1_1)-st query for searching a spawned location of at least one (k_1)-st sub item among the k-th sub item by referring to a viewing angle of the player, to thereby acquire a (k_1)-st spawned location information corresponding to the (k_1)-st sub item from the variable-value database, and (ii) determines whether at least one specific (k_1)-st sub item among the (k_1)-st sub item is located within the search target area by referring to the (k_1)-st spawned location information, and wherein, at the step of (b), in response to detecting that the specific (k_1)-st sub item is located within the search target area determined based on the specific location, the game server displays a (2_1)-st location-indicating marker corresponding to the specific (k_1)-st sub item at a matching spot of the 2-nd display area, wherein the matching spot corresponds to the (k_1)-st spawned location information of the specific (k_1)-st sub item.

As one example, there is provided a method, wherein, at the step of (a), the game server (i) further transmits a (1_2)-nd query for searching a spawned location of at least one (k_2)-nd sub item located outside a viewing angle of the player among the k-th sub item to the variable-value database, thereby further acquiring at least one (k_2)-nd spawned location information corresponding to the (k_2)-nd sub item from the variable-value database, and (ii) determines whether at least one specific (k_2)-nd sub item among the (k_2)-nd sub item within the search target area by further referring to the (k_2)-nd spawned location information, and wherein, at the step of (b), in response to further detecting that the specific (k_2)-nd sub item is located within the search target area determined based on the specific location, the game server further displays a (2_2)-nd location-indicating marker corresponding to the specific (k_2)-nd sub item at a non-matching spot in the 2-nd display area, wherein the non-matching spot corresponds to the (k_2)-nd spawned location information of the specific (k_2)-nd sub item.

As one example, there is provided a method, wherein, at the step of (b), the location-indicating marker corresponding to the specific sub item is displayed through at least part of the 1-st display area, the 2-nd display area and the 3-rd display area during a predetermined marker exposure time, wherein the marker exposure time contains a 1-st marker exposure time and a 2-nd marker exposure time according to time-sequential order, wherein (i) the location-indicating marker is displayed with a fixed 1-st degree of visibility during the 1-st marker exposure time, and (ii) the location-indicating marker is displayed with a variable 2-nd degree of visibility during the 2-nd marker exposure time, and wherein the variable 2-nd degree of visibility is less than the fixed 1-st degree of visibility.

As one example, there is provided a method, wherein, at the step of (a), the sub item information is acquired by performing at least part of (i) a process of determining at least part of a 1-st sub item corresponding to the main item according to a sub item determining algorithm of the game server; and (ii) a process of selecting a 2-nd sub item corresponding to the main item by the player.

In accordance with another aspect of the present disclosure, there is provided a game server for providing a battle royale game which allows players to search for sub items used for upgrading or repairing main items, including: at least one memory that stores instructions; and at least one processor configured to execute the instructions to perform or support another device to perform: (I) a process of, in response to acquiring an item search request containing (i) item information related to at least part of main item information on at least one main item corresponding to a player and sub item information related to at least one sub item corresponding to a player, and (ii) location information of the player in a field, wherein the sub item is an item to be used for upgrading the main item or for repairing the main item, determining or supporting another device to determine whether at least one specific sub item corresponding to the item information is located within a search target area determined based on a specific location corresponding to the location information of the player in the field, by referring to the item search request; and (II) in response to detecting that the specific sub item is located within the search target area determined based on the specific location, displaying or supporting another device to display a location-indicating marker corresponding to the specific sub item through at least part of (i) a 1-st display area for displaying azimuth information, (ii) a 2-nd display area for displaying the location information of the player in the field; and (iii) a 3-rd display area for displaying the location information of the player in the map.

As one example, there is provided a game server, wherein, at the process of (I), the processor detects whether the specific sub item corresponding to the item information is located in a 1-st search target area determined based on a 1-st specific location corresponding to the location information of the player in the field by referring to the item search request, and wherein, at the step of (b), in response to detecting that the specific sub item is not located in the 1-st search target area determined based on the 1-st specific location, the processor determines whether the specific sub item corresponding to the item information is located in a 2-nd search target area determined based on a 2-nd specific location by referring to information on the 2-nd specific location of the player acquired after a time for re-detection has elapsed, and in response to determining that the specific sub item is located in the 2-nd search target area determined based on the 2-nd specific location, displaying the location-indicating marker corresponding to the specific sub item through at least part of the 1-st display area, the 2-nd display area and the 3-rd display area.

As one example, there is provided a game server, comprising a process of: (III) in response to satisfying a specific condition which is one of (i) a 1-st condition that a preset marker exposure time elapsed from a specific timing when the location-indicating marker is displayed through at least part of the 1-st display area, the 2-nd display area and the 3-rd display area, (ii) a 2-nd condition that the specific sub item is acquired by the player in the marker exposure time from the specific timing; and (iii) a 3-rd condition that the specific sub item is acquired by another player in the marker exposure time from the specific timing and that the player moves to an item-adjacent region determined based on a location of the specific sub item in the marker exposure time from the specific timing, the processor blocking the location-indicating marker corresponding to the specific sub item which has been displayed through at least part of the 1-st display area, the 2-nd display area and the 3-rd display area.

As one example, there is provided a game server, on condition that information on each of a 1-st main item to an m-th main item, 1-st hierarchy information among at least one 1-st sub item corresponding to the 1-st main item to m-th hierarchy information among at least one m-th sub item corresponding to the m-th main item have been stored and managed in a fixed-value database, wherein, at the process of (I), spawned location information representing a location where at least part of the 1-st sub item to the m-th sub item is spawned in the field is stored and managed in a variable-value database, wherein, at the process of (II), in response to determining that the specific sub item is located in the search target area, the processor performs at least part of (i) a process of displaying at least one 1-st location-indicating marker in a 1-st mapping location matching with a direction which the player is currently looking at in the 1-st display area for displaying the azimuth information in a bar form, (ii) a process of displaying at least one 2-nd location-indicating marker in a 2-nd mapping location matching with a location of the specific sub item in the field in the 2-nd display area for displaying the location information in the field; and (iii) a process of displaying at least one 3-rd location-indicating marker in a 3-rd mapping location matching with a location of the specific sub item on the map in the 3-rd display area for displaying the location information on the map.

As one example, there is provided a game server, wherein, at the process of (II), the processor displays at least part of a specific 1-st location-indicating marker, a specific 2-nd location-indicating marker and a specific 3-rd location-indicating marker corresponding to a selected sub item for upgrading a selected main item among the specific sub item or repairing the selected main item by highlighting the specific 1-st location-indicating marker, the specific 2-nd location-indicating marker and the specific 3-rd location-indicating marker through at least part of the 1-st display area, the 2-nd display area and the 3-rd display area, and wherein the selected main item is an item selected by the player or the game server among the main item.

As one example, there is provided a game server, wherein, at the process of (II), the processor displays at least part of the specific 1-st location-indicating marker, the specific 2-nd location-indicating marker and the specific 3-rd location-indicating marker by highlighting the specific 1-st location-indicating marker, the specific 2-nd location-indicating marker and the specific 3-rd location-indicating marker through at least part of the 1-st display area, the 2-nd display area and the 3-rd display area, and wherein the processor (1) detects a specific necessity-degree, corresponding to the selected sub item, defined by a predetermined function having arguments of at least part of (i) information on whether at least one another player located in another player-related reference area determined based on the specific location of the player has selected the selected main item, (ii) information on a distance between the at least one another player and the selected sub item, and (iii) information on a velocity of the at least one another player approaching a location of the selected sub item, and (2) displays at least part of the specific 1-st location-indicating marker, the specific 2-nd location-indicating marker and the specific 3-rd location-indicating marker to correspond to the specific necessity-degree.

As one example, there is provided a game server, wherein, at the process of (II), in response to acquiring the item search request containing k-th main item information on a k-th main item among the 1-st main item to the m-th main item, k-th sub item information on at least one k-th sub item corresponding to the k-th main item, and the location information of the player in the field and the direction information of the player in the field, the processor (i) transmits a (1_1)-st query for searching a spawned location of at least one (k_1)-st sub item among the k-th sub item by referring to a viewing angle of the player, to thereby acquire a (k_1)-st spawned location information corresponding to the (k_1)-st sub item from the variable-value database, and (ii) determines whether at least one specific (k_1)-st sub item among the (k_1)-st sub item is located within the search target area by referring to the (k_1)-st spawned location information, and wherein, at the process of (II), in response to detecting that the specific (k_1)-st sub item is located within the search target area determined based on the specific location, the processor displays a (2_1)-st location-indicating marker corresponding to the specific (k_1)-st sub item at a matching spot of the 2-nd display area, wherein the matching spot corresponds to the (k_1)-st spawned location information of the specific (k_1)-st sub item.

As one example, there is provided a game server, wherein, at the step of (I), the processor (i) further transmits a (1_2)-nd query for searching a spawned location of at least one (k_2)-nd sub item located outside a viewing angle of the player among the k-th sub item to the variable-value database, thereby further acquiring at least one (k_2)-nd spawned location information corresponding to the (k_2)-nd sub item from the variable-value database, and (ii) determines whether at least one specific (k_2)-nd sub item among the (k_2)-nd sub item within the search target area by further referring to the (k_2)-nd spawned location information, and wherein, at the process of (II), in response to further detecting that the specific (k_2)-nd sub item is located within the search target area determined based on the specific location, the processor further displays a (2_2)-nd location-indicating marker corresponding to the specific (k_2)-nd sub item at a non-matching spot in the 2-nd display area, wherein the non-matching spot corresponds to the (k_2)-nd spawned location information of the specific (k_2)-nd sub item.

As one example, there is provided a game server, wherein, at the process of (II), the location-indicating marker corresponding to the specific sub item is displayed through at least part of the 1-st display area, the 2-nd display area and the 3-rd display area during a predetermined marker exposure time, wherein the marker exposure time contains a 1-st marker exposure time and a 2-nd marker exposure time according to time-sequential order, wherein (i) the location-indicating marker is displayed with a fixed 1-st degree of visibility during the 1-st marker exposure time, and (ii) the location-indicating marker is displayed with a variable 2-nd degree of visibility during the 2-nd marker exposure time, and wherein the variable 2-nd degree of visibility is less than the fixed 1-st degree of visibility.

As one example, there is provided a game server, wherein, at the process of (I), the sub item information is acquired by performing at least part of (i) a process of determining at least part of a 1-st sub item corresponding to the main item according to a sub item determining algorithm of the game server; and (ii) a process of selecting a 2-nd sub item corresponding to the main item by the player.

### BRIEF DESCRIPTION OF THE DRAWINGS

The accompanying drawings used to explain example embodiments of the present disclosure are only part of example embodiments of the present disclosure and other drawings can be obtained based on the drawings by those skilled in the art of the present disclosure without inventive work.

FIG. 1 is a drawing schematically illustrating a game server in accordance with one example embodiment of the present disclosure.

FIG. 2A and FIG. 2B are drawings schematically illustrating hierarchy information of main items and sub items in accordance with one example embodiment of the present disclosure.

FIG. 3 is a drawing schematically illustrating a process of acquiring an item search request through a player inventory UI in accordance with one example embodiment of the present disclosure.

FIG. 4 is a drawing schematically illustrating a process of acquiring an item search request through an item production tree UI in accordance with one example embodiment of the present disclosure.

FIG. 5 is a drawing schematically illustrating at least one location-indicating marker corresponding to a specific sub item in accordance with one example embodiment of the present disclosure.

FIG. 6 is a flowchart schematically illustrating a process of searching sub items to be used for upgrading or repairing a main item by the game server in accordance with one example embodiment of the present disclosure.

### DETAILED DESCRIPTION OF THE PREFERRED EMBODIMENTS

The following detailed description of the present disclosure refers to the accompanying drawings, which show by way of illustration a specific embodiment in which the present disclosure may be practiced, in order to clarify the objects, technical solutions and advantages of the present disclosure. These embodiments are described in sufficient detail to enable those skilled in the art to practice the present disclosure.

Besides, in the detailed description and claims of the present disclosure, a term “include” and its variations are not intended to exclude other technical features, additions, components or steps. Other objects, benefits and features of the present disclosure will be revealed to one skilled in the art, partially from the specification and partially from the implementation of the present disclosure. The following examples and drawings will be provided as examples but they are not intended to limit the present disclosure.

Furthermore, the present invention includes all possible combinations of embodiments indicated in the present disclosure. It is to be understood that the various embodiments of the present disclosure, although different, are not necessarily mutually exclusive. For example, a particular feature, structure, or characteristic described herein in connection with one embodiment may be implemented within other embodiments without departing from the spirit and scope of the present disclosure. In addition, it is to be understood that the position or arrangement of individual elements within each disclosed embodiment may be modified without departing from the spirit and scope of the present disclosure. The following detailed description is, therefore, not to be taken in a limiting sense, and the scope of the present disclosure is defined only by the appended claims, appropriately interpreted, along with the full range of equivalents to which the claims are entitled. In the drawings, like numerals refer to the same or similar functionality throughout the several views.

The headings and abstract of the present disclosure provided herein are for convenience only and do not limit or interpret the scope or meaning of the embodiments.

To allow those skilled in the art to carry out the present disclosure easily, the example embodiments of the present disclosure will be explained by referring to attached diagrams in detail as shown below.

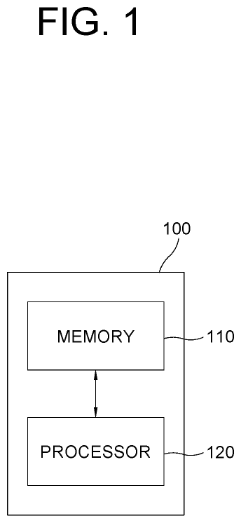

FIG. 1 is a drawing schematically illustrating a game server 100 in accordance with one example embodiment of the present invention, and the game server 100 may include at least one memory 110 that stores instructions for providing a battle royale game which allows players to search for sub items used for upgrading or repairing main items; and at least one processor 120 configured to execute the instructions to perform or support another device to perform a process for providing the battle royale game which allows the players to search for the sub items used for upgrading or repairing the main items corresponding to the instructions stored in the memory 110.

Specifically, the game server may achieve a desired system performance by using combinations of at least one computing device and at least one computer software, e.g., a computer processor, a memory, a storage, an input device, an output device, or any other conventional computing components, an electronic communication device such as a router or a switch, an electronic information storage system such as a network-attached storage (NAS) device and a storage area network (SAN) as the computing device and any instructions that allow the computing device to function in a specific way as the computer software.

The processor of the computing device may include hardware configuration of MPU (Micro Processing Unit) or CPU (Central Processing Unit), cache memory, data bus, etc. Additionally, the computing device may further include OS and software configuration of applications that achieve specific purposes.

However, the case in which the computing device includes an integrated processor, integrating a medium, a processor and a memory, for implementing the present disclosure is not excluded.

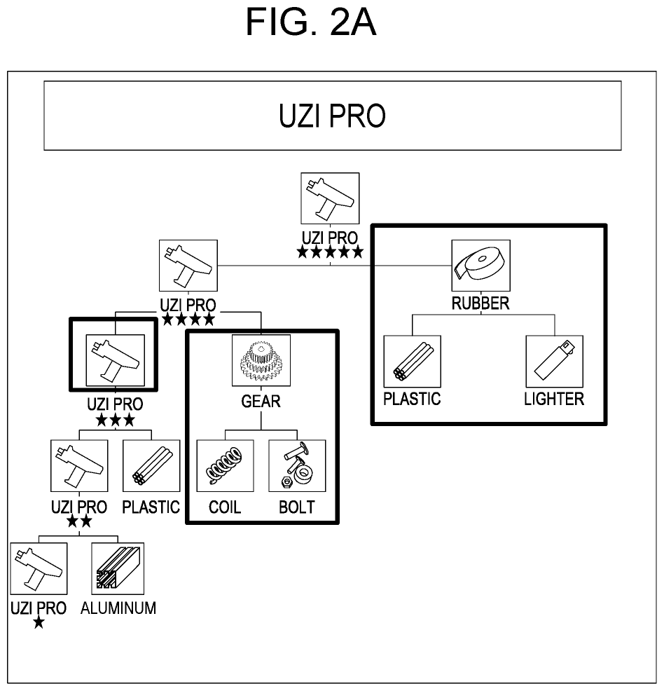

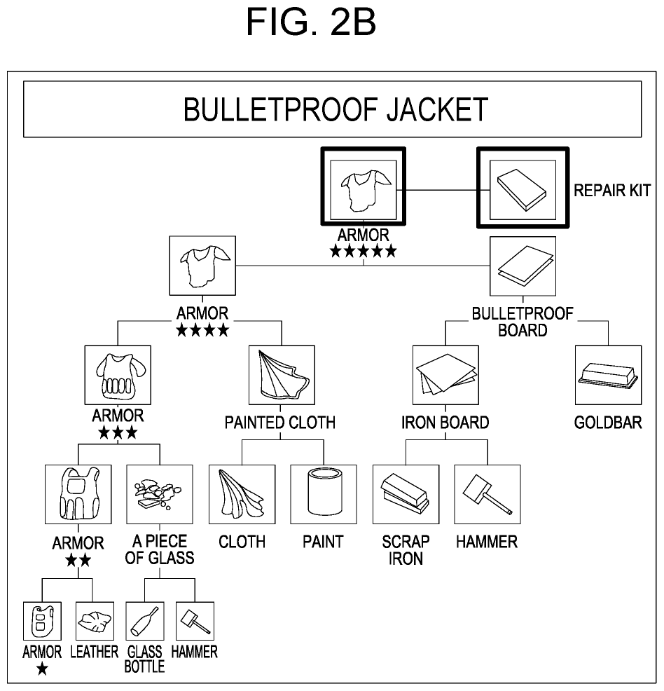

A process of providing the battle royale game which allows the players to search for the sub items used for upgrading or repairing the main items configured as explained above is described by referring to FIGS. 2A to 6.

As used in this specification and the appended claims, the singular forms “a,” “an,” and “the” may include plural referents unless a content or a context clearly dictates otherwise.

Firstly, the game server 100 may acquire an item search request containing (i) item information related to at least part of main item information on at least one main item corresponding to a specific player and sub item information related to at least one sub item corresponding to the specific player, and (ii) location information of the specific player in a field.

Herein, after explaining as to the main item and the sub item by referring to FIG. 2A and FIG. 2B in order to facilitate understanding, the overall processes will be explained.

For reference, the main item according to one embodiment of the present invention may be at least part of a gun, a protective item and a bag, and the sub item may be an item for upgrading the main item or for repairing the main item.

For example, the main item may be an item which the specific player can be equipped with.

In addition, the sub item may be an item for upgrading the main item or repairing the main item, and may be an item which the specific player cannot be equipped with, but it is not limited thereto. As another example, at least part of the sub item may be an item which can be equipped by the specific player.

By referring to FIG. 2A, it can be confirmed that a main item (for example, UZI Pro) and sub items (for example, aluminum, plastic, coil, bolt, gear, lighter and rubber, etc.) for upgrading the main item are hierarchically illustrated.

In addition, by referring to FIG. 2B, it can be confirmed that another main item and sub items (for example, leather, glass bottle, hammer, pieces of glass, cloth, paint, scrap iron, painted cloth, iron board, gold bar, bulletproof board, and repair kit) for upgrading said another main item are hierarchically illustrated.

As such, information on each of a 1-st main item to an m-th main item, 1-st hierarchy information among 1-st sub items corresponding to the 1-st main item to m-th hierarchy information among m-th sub items corresponding to the m-th main item have been stored and managed in a database. Herein, m may be an integer of 2 or more.

For reference, even if their item levels are different, if names of the main items are identical, they may be considered as included in the identical main item. For example, the game server 100 may (i) manage an UZI Pro of one-star (marked with one star shape) level to an UZI Pro of five-star (marked with five star shapes) level as a 7-th main item, and (ii) manage a bulletproof jacket of one-star level to a bulletproof jacket of five-star level as a 30-th main item. In addition, the game server 100 may (i) manage materials (for example, aluminum, plastic, coil, bolt, gear, lighter and rubber, etc.) for upgrading or repairing the 7-th main item (for example, the one-star UZI Pro to the five-star UZI Pro) as 7-th sub items, and (ii) manage materials (for example, leather, glass bottle, hammer, pieces of glass, cloth, paint, painted cloth, iron board, gold bar, bulletproof board and repair kit) for upgrading or repairing the 30-th main item (for example, the one-star bulletproof jacket to the five-star bulletproof jacket) as 30-th sub items.

For reference, 1-st hierarchy information to m-th hierarchy information may be stored and managed in a fixed-value database where information thereon is not changed according to each of games executed for each turn of execution. Herein, each of the 1-st hierarchy information to the m-th hierarchy information includes each of information on hierarchy among levels of the 1-st main item to information on hierarchy among levels of the m-th main item, each of information on hierarchy among levels of the 1-st sub item to information on hierarchy among levels of the m-th sub item, and each of information on hierarchy between each of the levels of the 1-st main item and each of the levels of the 1-st sub item to information on hierarchy between each of the levels of the m-th main item and each of the levels of the m-th sub item.

However, the embodiment of the present invention is not limited thereto. For example, the hierarchical information among the main item and the sub items, information thereon may be changed according to each of the games executed for each turn of execution, or information thereon may be changed according to map information of each of the games.

Meanwhile, locations which the sub items are spawned in the field may be changed for each turn of execution of a game, and thus spawned location information representing locations where the sub items are spawned in the field may be stored and managed in a variable-value database.

For reference, the fixed-value database and the variable-value database may be separate databases, but they are not limited thereto, and may be configured as an identical database.

In addition, sub item information contained in the item search request may be acquired by performing at least part of (i) a process of determining at least part of 1-st type sub items corresponding to the main item according to a sub item determining algorithm of the game server 100; and (ii) a process of selecting 2-nd type sub items corresponding to the main item by the specific player.

As an example, even if sub items are not selected by the specific player, the 1-st type sub items to be used in upgrading or repairing the main item which the specific player is currently equipped with or which can be equipped by the specific player in the future may be determined according to the sub item determining algorithm.

Herein, the 1-st type sub items may be determined at random among the sub items, but it is not limited thereto.

For example, on condition that each of weights has been set for each of sub items corresponding to each of a gun, a protective item and a bag, the 1-st type sub items may be determined.

Alternatively, sub items to be used in upgrading or repairing a specific main item currently equipped or to be equipped in the future by the specific player may be determined as the 1-st type sub items. Herein, in case the specific player possesses a sufficient amount of a specific sub item required to upgrade or repair the specific main item currently equipped by the specific player, the remaining sub items excluding the specific sub item may be determined as the 1-st type sub items.

Alternatively, another specific sub item to be used in upgrading or repairing the most recently equipped main item may be determined as the 1-st type sub items.

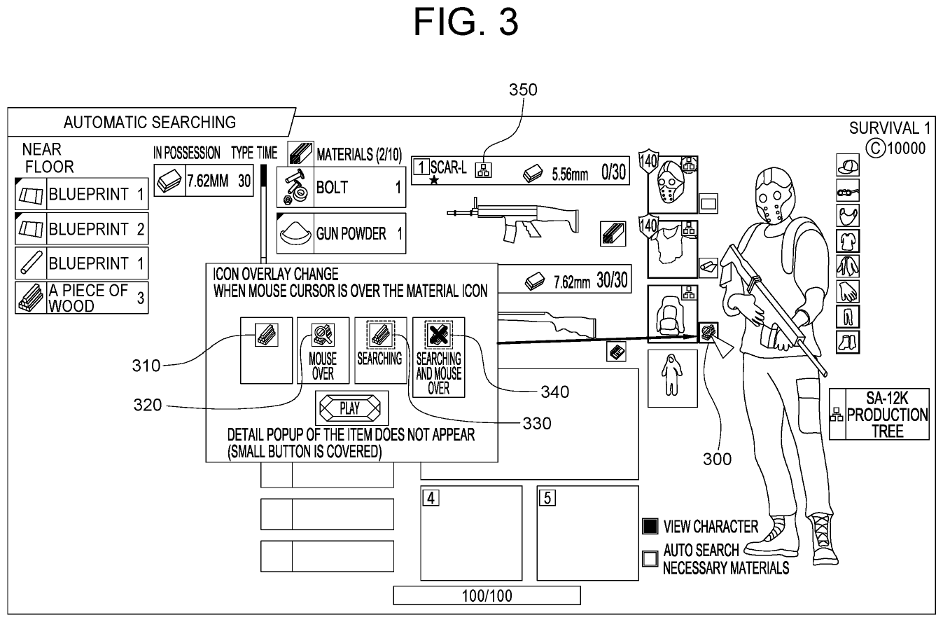

As still another example, an item search request containing information on the 2-nd type sub items may be acquired by allowing the specific player to select the 2-nd type sub items, which will be explained in more detail by referring to FIG. 3 below.

FIG. 3 is a drawing schematically illustrating a process of acquiring an item search request through a player inventory UI in accordance with one example embodiment of the present disclosure.

By referring to FIG. 3, the game server 100 may display the inventory UI of the specific player by dividing it into “ambient” area, “in possession” area, “producing” area (not shown) and “materials” area.

For reference, information displayed through the “ambient” area, the “in possession” area, the “producing” area and the “materials” area include at least part of information on a name, a thumbnail, a level, a need for repair, an execution shortcut key, essential materials, a manufacturability, a current quantity in possession and a maximum quantity in possession of an item at issue.

For example, by referring to FIG. 3, it can be confirmed that (i) through the “ambient” area, information on items “blueprints” and an item “a piece of wood” for upgrading or repairing a specific item is displayed as information on items present at a short distance from the specific player, (ii) through the “in possession” area, information on an item “7.62 mm bullet” is displayed as information on one of items excluding material items (that is, sub items) among the items which the specific player is currently in possession, and (iii) through “materials” area, information on an item “bolt” and an item “gunpowder” is displayed as information on the material items (that is sub items) among the items which the character is currently in possession.

In addition, the game server 100 may allow at least part of (i) information on how many types of sub items at maximum can be possessed by the character of a user, and (ii) information on how many types of sub items are currently possessed by the character of the user to be displayed.

For example, the game server 100 may allow “2/10” to be displayed through the “materials” area, and thus support the user to easily confirm that 10 types of the sub items at maximum can be possessed and 2 types of the sub items are currently in possession.

In addition, the game server 100 may allow at least part of information on weapons, protective items and other items which the specific player is currently in possession to be displayed through the inventory UI of the specific player.

As one example, as shown in FIG. 3, the game server 100 may allow information on the weapons (SCAR-L, etc.), information on the protective items (bulletproof helmet, armor) and other items (bags, camouflage suit), which the specific player is currently in possession, to be displayed through the inventory UI of the specific player.

For example, the game server 100 may allow (i) information that the current level of SCAR-L is one-star (marked with one star) and (ii) information that aluminum is a necessary material for upgrading one-star SCAR-L to two-star SCAR-L to be displayed, as information on SCAR-L which the specific player is currently in possession.

The game server 100 may acquire the item search request by supporting a predetermined sub item to be selected by the specific player through the inventory UI displayed as above.

As one example, as shown in FIG. 3, on condition that a thumbnail 300 of the item “a piece of wood” for upgrading a bag is displayed, in response to detecting that a mouse cursor of a user is located on the thumbnail 300 of the item “a piece of wood,” the game server 100 may allow the thumbnail of the item “a piece of wood” (which has been displayed as in the reference numeral 310) to be displayed as in the reference numeral 320, and thus provide information that the item search request for the item “a piece of wood” is possible to the user. In addition, on condition that a magnifying glass shape is further marked on the thumbnail of the item “a piece of wood” as in the reference numeral 320, in response to acquiring the item search request on the item “a piece of wood” by selection (clicking) of the thumbnail of the item “a piece of wood” by the user, the game server 100 may provide information that a search is currently being performed for the item at issue to the user by highlighting the thumbnail of the item “a piece of wood” as in the reference numeral 330. In addition, while performing the search for the item “a piece of wood,” in response to detecting that a mouse cursor is located on the thumbnail of the item “a piece of wood,” the game server 100 may support the user to determine whether to stop the search for the item “a piece of wood” by marking “X” on the thumbnail of the item “a piece of wood” as in the reference numeral 340.

Meanwhile, the game server 100 according to one example embodiment of the present invention may allow an icon for confirming item production information (expressed by a tree structure) to be displayed.

By referring to FIG. 3 again, it can be confirmed that an icon 350 for confirming the production information displayed on the thumbnail or near the thumbnail of a bulletproof helmet, armor, bag, weapon, etc. which the specific player is currently equipped with.

In addition, when a specific icon corresponding to a specific item is selected by a user, the game server 100 may allow production information for the specific item to be displayed.

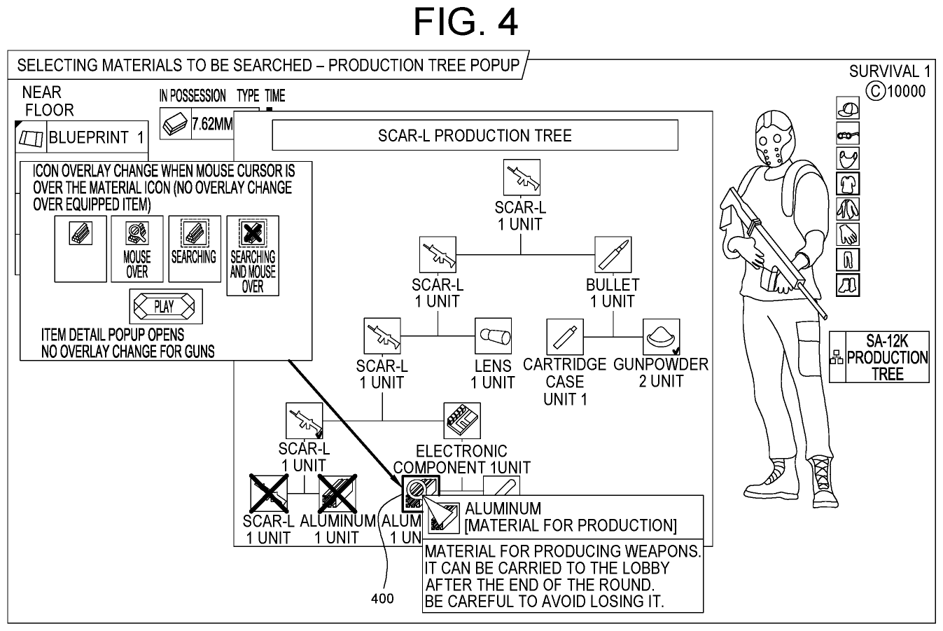

FIG. 4 is a drawing schematically illustrating production information (e.g., production tree) for the specific item according to one example embodiment of the present disclosure.

By referring to FIG. 4, it can be confirmed that as the icon 350 for confirming production information for SCAR-L gun is selected by the user, the production information for SCAR-L is displayed.

As one example, in case the specific player is currently in possession of two-star SCAR-L weapon, the production information for one-star SCAR-L which is at lower level may be unnecessary, and thus as shown in FIG. 4, an area corresponding to one-star SCAR-L (that is, the main item) and the item aluminum (that is, the sub item) corresponding thereto may be displayed in dark.

In addition, by referring to FIG. 4, one item “electronic component” is necessary as the sub item for the specific player to upgrade the two-star SCAR-L currently in possession. In addition, one item “aluminum” and one item “plastic” are necessary as lower-level sub items to produce the item “electronic component” as the upper-level sub item.

Herein, similar to the explanation with a reference to FIG. 3, the game server 100 may acquire the item search request, etc. by supporting the specific player to select a thumbnail of a predetermined sub item on the production tree.

In addition, in response to acquiring the item search request, the game server 100 may determine whether at least one specific sub item corresponding to the item information is located within a search target area, determined based on a specific location corresponding to the location information of the specific player in the field, by referring to the item search request.

For reference, the search target area may be determined according to various manners based on the specific location.

As one example, an area satisfying a predetermined distance range (for example, (i) 10 m to 200 m or (ii) Om to 100 m) based on the specific location of the specific player may be determined as the search target area.

As another example, an area satisfying the predetermined distance range based on the specific location of the specific player and located within a viewing angle of the specific player based on a direction which the specific player is currently looking at may be determined as the search target area.

As still another example, an area including the specific location of the specific player may be determined as the search target area.

In addition, the specific sub item is located within the search target area determined based on the specific location, the game server 100 may display a location-indicating marker corresponding to the specific sub item through at least part of (i) a 1-st display area for displaying azimuth information, (ii) a 2-nd display area for displaying the location information of the specific player in the field; and (iii) a 3-rd display area for displaying the location information of the specific player in the map.

To this point, the overall flow of the game server 100 displaying the location-indicating marker corresponding to the specific sub item was schematically explained, and processes of the game server 100 displaying the location-indicating marker will be more specifically explained below.

As one example, in response to detecting that the specific sub item is located within the search target area, the game server 100 may perform at least part of (i) a process of displaying at least one 1-st location-indicating marker at a 1-st mapping location matching with a direction which the specific player is currently looking at in the 1-st display area for displaying the azimuth information in a bar form, (ii) a process of displaying at least one 2-nd location-indicating marker at a 2-nd mapping location matching with a location of the specific sub item in the field in the 2-nd display area for displaying the location information in the field; and (iii) a process of displaying at least one 3-rd location-indicating marker at a 3-rd mapping location matching with a location of the specific sub item on the map in the 3-rd display area for displaying the location information on the map.

Herein, the azimuth information displayed through the 1-st display area may be displayed through the 1-st display area regardless of the direction that the specific player is looking at, but it is not limited thereto.

That is, the azimuth information may be displayed through the 1-st display area to correspond to the direction that the specific player is looking at. For example, in case the specific player is looking at North, a central portion of the 1-st display area may display N or 0, and in case the specific player is looking at East, a central portion of the 1-st display area may display E or 90.

Herein, the game server 100 may display the location-indicating marker corresponding to the specific sub item among the specific sub items to be emphasized compared to location-indicating markers corresponding to other sub items.

For example, the game server 100 may display at least part of a specific 1-st location-indicating marker, a specific 2-nd location-indicating marker and a specific 3-rd location-indicating marker corresponding to the selected sub item (among the specific sub items) for upgrading a selected main item or repairing the selected main item by highlighting at least part of the specific 1-st location-indicating marker, the specific 2-nd location-indicating marker and the specific 3-rd location-indicating marker through at least part of the 1-st display area, the 2-nd display area and the 3-rd display area.

As one example, the selected main item is an item selected by the specific player or the game server 100 among the main items. As another example, the selected main item may be a specific main item most recently looted (i.e., acquired) or most recently equipped by the specific player among the plurality of main items.

Herein, the game server 100 may detect a specific necessity-degree, corresponding to the selected sub item, defined by a predetermined function having arguments of at least part of (i) information on whether at least one another player located in another player-related reference area determined based on the specific location of the specific player has selected the selected main item, (ii) information on a distance between the at least one another player and the selected sub item, and (iii) information on a velocity of the at least one another player approaching a location of the selected sub item.

For reference, said another player-related reference area may be an area of the field that the specific player is capable of arriving at, but it is not limited thereto. For example, said another player-related reference area may be the area within a radius of 100 m based on the specific location of the specific player.

As one example, the specific necessity-degree defined by the predetermined function having arguments of at least part of (i) information whether said another player also has selected the same main item as the main item selected by the specific player in order for said another player to find upgrading materials (that is, selected sub item), (ii) information whether said another player is located within a close distance (for example, 30 m) from the selected sub item, and (iii) information whether said another player is approaching the selected sub item at a high speed (for example, 9 km/h), may be determined as a high-level necessity-degree.

As another example, the specific necessity-degree defined by the predetermined function having arguments of at least part of (i) information whether said another player has selected a different main item from the main item selected by the specific player, (ii) information whether said another player is located at a far distance (for example, 1 km) from the selected sub item, and (iii) information whether said another player is approaching the selected sub item at a low speed (for example, 3 km/h), may be determined as a low-level necessity-degree.

In addition, the game server 100 may display at least part of the specific 1-st location-indicating marker, the specific 2-nd location-indicating marker and the specific 3-rd location-indicating marker to correspond to the specific necessity-degree.

As one example, in case the specific necessity-degree is determined as the highest-level necessity-degree, the game server 100 may allow a splendid visual effect to be added to at least part of the specific 1-st location-indicating marker, the specific 2-nd location-indicating marker and the specific 3-rd location-indicating marker, and thus support the user controlling the specific player to immediately recognize the fact that at least part of the specific 1-st location-indicating marker, the specific 2-nd location-indicating marker and the specific 3-rd location-indicating marker is displayed.

As still another example, in case the specific necessity-degree is determined as the lowest level necessity-degree, the game server 100 may display at least part of the specific 1-st location-indicating marker, the specific 2-nd location-indicating marker and the specific 3-rd location-indicating marker with small sizes, and thus support the user who controls the specific player to avoid being distracted by the location-indicating markers.

In addition, the game server 100 may perform a sub item search by referring to a viewing angle of the specific player.

As one example, in response to acquiring the item search request containing k-th main item information on a k-th main item among the 1-st main item to the m-th main item, k-th sub item information on at least one k-th sub item corresponding to the k-th main item, and the location information of the specific player in the field and the direction information of the specific player in the field, the game server 100 may (i) transmit a (1_1)-st query for searching a spawned location of at least one (k_1)-st sub item among the k-th sub items by referring to the viewing angle of the specific player, to thereby acquire a (k_1)-st spawned location information corresponding to the (k_1)-st sub item from the variable-value database, and (ii) determine whether at least one specific (k_1)-st sub item among the (k_1)-st sub items is located within the search target area by referring to the (k_1)-st spawned location information.

In addition, in response to detecting that the specific (k_1)-st sub item is located within the search target area determined based on the specific location, the game server 100 may display a (2_1)-st location-indicating marker corresponding to the specific (k_1)-st sub item at a matching spot of the 2-nd display area.

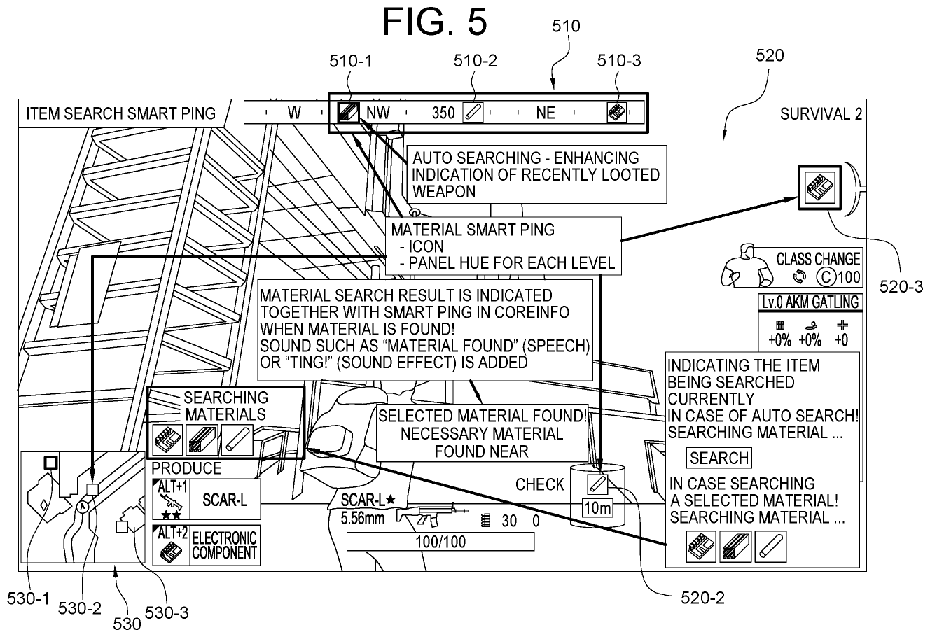

For reference, the matching spot may correspond to the (k_1)-st spawned location information of the specific (k_1)-st sub item. For reference, the explanation on the matching spot and the non-matching spot to be described later will be provided more specifically by referring to FIG. 5.

Herein, the game server 100 may (i) further transmit a (1_2)-nd query for searching a spawned location of at least one (k_2)-nd sub item located outside the viewing angle of the specific player among the k-th sub items to the variable-value database, thereby further acquiring at least one (k_2)-nd spawned location information corresponding to the (k_2)-nd sub item from the variable-value database, and (ii) further determine whether at least one specific (k_2)-nd sub item among the (k_2)-nd sub items within the search target area by further referring to the (k_2)-nd spawned location information.

For reference, the (1_1)-st query and the (1_2)-nd query may be included in one query, but they are not limited thereto, and they may be transmitted as separate search queries to the variable-value database.

In addition, in response to further detecting that the specific (k_2)-nd sub item is located within the search target area determined based on the specific location, the game server 100 may further display a (2_2)-nd location-indicating marker corresponding to the specific (k_2)-nd sub item at a non-matching spot in the 2-nd display area.

For reference, the non-matching spot may correspond to the (k_2)-nd spawned location information of the specific (k_2)-nd sub item.

Meanwhile, the game server 100 may display the location-indicating marker corresponding to the specific sub item through at least part of the 1-st display area, the 2-nd display area and the 3-rd display area during a predetermined marker exposure time.

Herein, the marker exposure time may contain a 1-st marker exposure time and a 2-nd marker exposure time according to time-sequential order, and the game server 100 may allow (i) the location-indicating marker to be displayed with a fixed 1-st degree of visibility during the 1-st marker exposure time, and (ii) the location-indicating marker to be displayed with a variable 2-nd degree of visibility during the 2-nd marker exposure time, and wherein the variable 2-nd degree of visibility is less than the fixed 1-st degree of visibility.

As one example, on condition that the marker exposure time is set to 60 seconds which includes 55 seconds corresponding to the 1-st marker exposure time and 5 seconds corresponding to the 2-nd marker exposure time, the game server 100 may allow the location-indicating marker to be displayed with the visibility of the location-indicating marker is fixed for 55 seconds, and then to be displayed such that the location-indicating marker to be gradually faded for the remaining 5 seconds.

Meanwhile, a case where a specific sub item is not located within the search target area determined based on the current location of the specific player may occur.

As one example, in response to the item search request, although the game server 100 tries to determine whether the specific sub item corresponding to the item information is located within a 1-st search target area determined based on a 1-st specific location corresponding to the location information of the specific player in the field, it may determine that the specific sub item is not located within the 1-st search target area determined based on the 1-st specific location.

In such a case, the game server 100 may repeat processes of re-determining whether the specific sub item corresponding to the item information is located in a 2-nd search target area determined based on a 2-nd specific location of the specific player acquired after a time for re-detection (for example, 10 seconds) has elapsed.

In addition, in response to determining that the specific sub item is located in the 2-nd search target area determined based on the 2-nd specific location, the game server 100 may display the location-indicating marker corresponding to the specific sub item through at least part of the 1-st display area, the 2-nd display area and the 3-rd display area. As another example, while the processes of re-determining whether the specific sub item is located is being performed repeatedly, the search may be cancelled by the specific player.

Meanwhile, FIG. 5 is a drawing schematically illustrating at least one location-indicating marker corresponding to the specific sub item.

By referring to FIG. 5, it can be confirmed that a 1-st location-indicating marker 510_1 corresponding to an item “aluminum,” a 1-st location-indicating marker 510_2 corresponding to an item “plastic” and a 1-st location-indicating marker 510_3 corresponding to an item “electronic component” are displayed at their corresponding 1-st mapping locations in the 1-st display area 510 for displaying the azimuth information on the basis of a direction which the specific player is currently looking at.

For example, it can be confirmed that the specific player of FIG. 5 is currently looking at 350 degrees in direction, and the item “plastic” is located at about 20 degrees in a direction clockwise from the direction of the specific player, and thus the 1-st location-indicating marker 510_1 corresponding to the item “plastic is displayed at a location corresponding to about 370 degrees on the 1-st display area 510.

In addition, it can be confirmed that a location-indicating marker 520_2 corresponding to the item “plastic” and a location-indicating marker 520_3 corresponding to the item “electronic component” are displayed through a 2-nd display area 520 for displaying the location information of the specific player in the field.

For example, the item “plastic” is located at about 20 degrees in a direction clockwise from the direction of the specific player of FIG. 5, and it is located within the viewing angle of the specific player, and thus the location where the item “plastic” has actually been spawned may be indicated in the 2-nd display area for displaying objects, etc. present in the viewing angle of the specific player. Accordingly, as shown in FIG. 5, the 2-nd location-indicating marker 520_2 corresponding to the item “plastic” may be displayed at the matching spot (that is, the spot on the 2-nd display area corresponding to the spawned location information of the item “plastic”) on the 2-nd display area.

In contrast, the item “electronic component” is located at about 120 degrees in a direction clockwise from the direction of the specific player of FIG. 5, and it is located outside the viewing angle of the specific player, and thus the location where the item “electronic component” has actually been spawned may fail to be indicated in the 2-nd display area for displaying objects, etc. present in the viewing angle of the specific player. Accordingly, as shown in FIG. 5, the 2-nd location-indicating marker 520_3 corresponding to the item “electronic component” may be displayed at the non-matching spot (that is, the spot on the 2-nd display area corresponding to the spawned location information of the item “electronic component”) on the 2-nd display area.

For reference, in FIG. 5, a 2-nd location-indicating marker corresponding to the item “aluminum” is omitted from the 2-nd display area 520, but it can be easily understood that the 2-nd locating-indicating marker of the item “aluminum” will be displayed to correspond to the actual spawned location of the item “aluminum” in the 2-nd display area.

In addition, it can be confirmed that the location-indicating marker 530_1 corresponding to the item “aluminum,” the location-indicating marker 530_2 corresponding to the item “plastic” and the location-indicating marker 530_3 corresponding to the item “electronic component” are displayed through a 3-rd display area 530 for displaying the location information of the specific player on the map, such that the location-indicating marker 530_1, the location-indicating marker 530_2, and the location-indicating marker 530_3 correspond to the spawned location information of each of the items on the map.

Meanwhile, the game server 100 may remove (e.g., block) the location-indicating marker which have been displayed through at least part of the 1-st display area, the 2-nd display area and the 3-rd display area.

As one example, in response to satisfying a specific condition which is one of (i) a 1-st condition that a preset marker exposure time elapsed from a specific timing when a specific location-indicating marker is displayed through at least part of the 1-st display area, the 2-nd display area and the 3-rd display area, (ii) a 2-nd condition that the specific sub item is acquired by the specific player in the marker exposure time from the specific timing; and (iii) a 3-rd condition that the specific sub item is acquired by another player in the marker exposure time from the specific timing and that the specific player moves to an item-adjacent region determined based on a location of the specific sub item in the marker exposure time from the specific timing, the game server 100 may block the specific location-indicating marker corresponding to the specific sub item which has been displayed through at least part of the 1-st display area, the 2-nd display area and the 3-rd display area.

Among them, further explanation is provided specifically on the 3-rd condition below.

For example, under the circumstance that the specific location-indicating marker corresponding to the specific sub item is displayed as a search for the specific sub item has been successful, even in the case where another player (that is, the competitor of the specific player) discovers the specific sub item and acquires the specific sub item ahead of the specific player, the game server 100 may allow the specific location-indicating marker for the specific sub item to be still displayed through at least part of the 1-st display area to the 3-rd display area of the specific player. Therethrough, the game server 100 may induce battles between the specific player and said another player by inducing the specific player to move to the spawned location of the specific sub item without recognizing the fact that the specific sub item has been acquired by said another player.

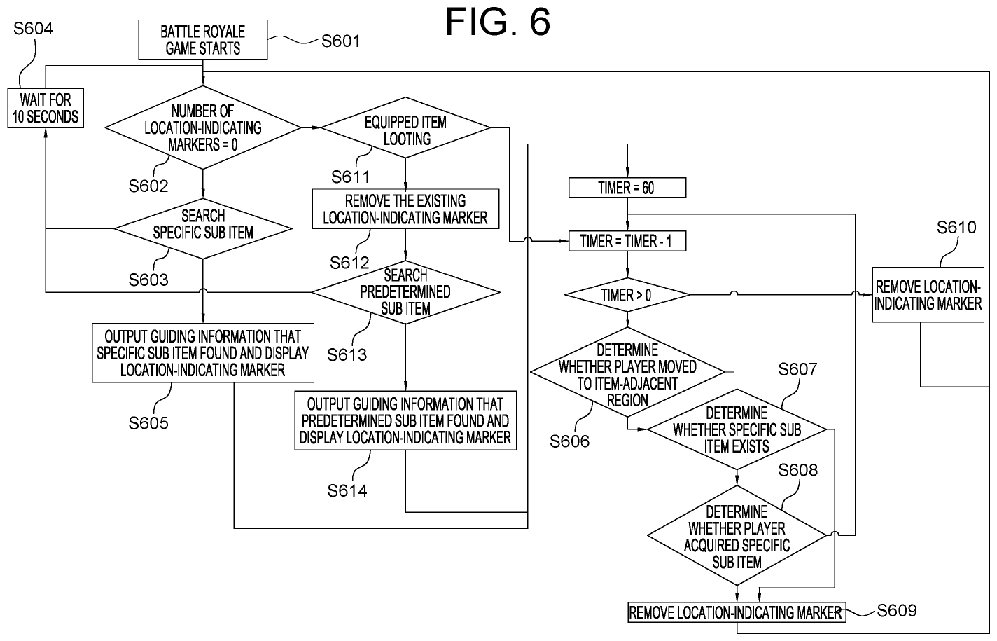

FIG. 6 is a flowchart schematically illustrating a process of searching a sub item to be used for upgrading or repairing a main item.

Explaining by referring to FIG. 6, after the battle royale game is started at a step of S601, the game server 100 may determine the number of the location-indicating marker being displayed currently.

If the number of the location-indicating marker being displayed currently is determined as 0 at a step of S602, the game server 100 may perform a search for a specific sub item at a step of S603. As one example, the game server 100 may determine whether the specific sub item is located within the search target area determined based on the specific location corresponding to the location information of the specific player in the field by referring to information on the sub item selected by a selection of the specific player or the game server 100.

Herein, in response to detecting that the specific sub item is not located within the search target area, the game server 100 may repeat the processes after re-detection time of 10 seconds elapses at a step of S604.

In contrast, in response to detecting that the specific sub item is located within the search target area, the game server 100 may output guiding information (for example, text information and/or speech information) that the specific sub item is successfully found through the user terminal, and display the location-indicating marker corresponding to the specific sub item for a preset time (for example, 60 seconds) at a step of S605.

In addition, the game server 100 may determine whether the specific player moves to an item-adjacent region determined based on a spawned location of the specific sub item in a preset time at a step of S606.

In addition, in response to detecting that the specific player moves to the item-adjacent region in the preset time, the game server 100 may determine whether the specific sub item is located on the spawned location at a step of S607.

If it is determined that the specific sub item is no longer located in the spawned location as the specific sub item has already been acquired by another player, the game server 100 may remove the location-indicating marker corresponding to the specific sub item at a step of S609.

Meanwhile, on condition that the specific sub item is determined as located on the spawned location as the specific sub item has not been acquired by another player, in response to detecting that the specific sub item was acquired by the specific player at a step of S608, the game server 100 may remove the location-indicating marker corresponding to the specific sub item at a step of S609.

In addition, in case the specific player cannot acquire the specific sub item in the preset time, the game server 100 may remove the location-indicating marker corresponding thereto at a step of S610.

Meanwhile, in response to detecting that the number of location-indicating marker being displayed currently is one or more, the game server 100 may determine whether an equipped item (for example, the main item) has been looted (acquired) by the specific player at a step of S611.

In addition, in response to detecting that the equipped item (for example, the main item) was looted by the specific player, the game server 100 may remove the location-indicating marker displayed previously at a step of S612.

In addition, the game server 100 may search for a predetermined sub item corresponding to the equipped item looted by the specific player through identical/similar processes explained above at a step of S613, and then may output guiding information (for example, text information and/or speech information) for the predetermined sub item and display the location-indicating marker at a step of S614.

Through the processes above, the game server 100 in accordance with one example embodiment of the present invention performs a search for various items, and allows their corresponding location-indicating markers to be displayed through various manners with respect to the searched items, thereby supporting the specific player to collect the searched items by accurately identifying the locations of the searched items.

Therethrough, opportunities for using more various combinations of the items are provided to the users, and the users can establish various strategies in an extreme competition for survival, and thus tension and interest in the battle royale game is maintained continuously.

In addition, the game server 100 may induce the battles among the players who are intending to move toward the location-indicating marker.

The present disclosure has an effect of supporting players participating in a battle royale game to be capable of easily upgrading or repairing main items.

The present disclosure has another effect of automatically searching sub items used in upgrading or repairing of main items.

The present disclosure has still another effect of supporting the players to easily acquire the sub items by displaying one or more location-indicating markers corresponding to the sub items.

The present disclosure has still yet another effect of inducing battles among the players participating in the battle royale game, thereby preventing the users controlling the players of the battle royale game from losing interest easily.

Besides, the embodiments of the present disclosure as explained above can be implemented in a form of executable program command through a variety of computer means recordable to computer readable media. The computer readable media may store solely or in combination, program commands, data files, and data structures. The program commands recorded in the media may be components specially designed for the present disclosure or may be usable for a skilled human in a field of computer software. The computer readable media include, but are not limited to, magnetic media such as hard drives, floppy diskettes, magnetic tapes, memory cards, solid-state drives, USB flash drives, optical media such as CD-ROM and DVD, magneto-optical media such as floptical diskettes and hardware devices such as a read-only memory (ROM), a random access memory (RAM), and a flash memory specially designed to store and carry out program commands. Program commands may include not only a machine language code made by a compiler but also a high level code that can be used by an interpreter etc., which is executed by a computer. The aforementioned hardware device may work as more than a software module to perform the action of the present disclosure and they may do the same in the opposite case. The hardware device may include a processor such as a CPU or a GPU, combined with a memory device such as ROM or RAM to store the program commands, configured to execute the commands stored in the memory, and a communication part which can exchange signals with external devices. In addition, the hardware device may include a keyboard, a mouse, and any other external input device to receive commands prepared by developers.

As seen above, the present disclosure has been explained by specific matters such as detailed components, limited embodiments, and drawings. While the invention has been shown and described with respect to the preferred embodiments, it, however, will be understood by those skilled in the art that various changes and modification may be made without departing from the spirit and scope of the invention as defined in the following claims.

Accordingly, the thought of the present disclosure must not be confined to the explained embodiments, and the following patent claims as well as everything including variations equal or equivalent to the patent claims pertain to the category of the thought of the present disclosure.

What is claimed is:

1. A method for providing a battle royale game which allows players to search for sub items used for upgrading or repairing main items, comprising steps of:
(a) in response to acquiring an item search request containing (i) item information related to at least part of main item information on at least one main item corresponding to a player and sub item information related to at least one sub item corresponding to a player, and (ii) location information of the player in a field, wherein the sub item is an item to be used for upgrading the main item or for repairing the main item, a game server determining or supporting another device to determine whether at least one specific sub item corresponding to the item information is located within a search target area determined based on a specific location corresponding to the location information of the player in the field, by referring to the item search request; and
(b) in response to detecting that the specific sub item is located within the search target area determined based on the specific location, the game server displaying or supporting another device to display a location-indicating marker corresponding to the specific sub item through at least part of (i) a 1-st display area for displaying azimuth information, (ii) a 2-nd display area for displaying the location information of the player in the field; and (iii) a 3-rd display area for displaying the location information of the player in the map.

2. The method of claim 1, wherein, at the step of (a), the game server detects whether the specific sub item corresponding to the item information is located in a 1-st search target area determined based on a 1-st specific location corresponding to the location information of the player in the field by referring to the item search request, and
wherein, at the step of (b), in response to detecting that the specific sub item is not located in the 1-st search target area determined based on the 1-st specific location, the game server determines whether the specific sub item corresponding to the item information is located in a 2-nd search target area determined based on a 2-nd specific location by referring to information on the 2-nd specific location of the player acquired after a time for re-detection has elapsed, and in response to determining that the specific sub item is located in the 2-nd search target area determined based on the 2-nd specific location, displaying the location-indicating marker corresponding to the specific sub item through at least part of the 1-st display area, 2-nd display area and the 3-rd display area.

3. The method of claim 1, further comprising a step of:
(c) in response to satisfying a specific condition which is one of (i) a 1-st condition that a preset marker exposure time elapsed from a specific timing when the location-indicating marker is displayed through at least part of the 1-st display area, the 2-nd display area and the 3-rd display area, (ii) a 2-nd condition that the specific sub item is acquired by the player in the marker exposure time from the specific timing; and (iii) a 3-rd condition that the specific sub item is acquired by another player in the marker exposure time from the specific timing and that the player moves to an item-adjacent region determined based on a location of the specific sub item in the marker exposure time from the specific timing, the game server blocking the location-indicating marker corresponding to the specific sub item which has been displayed through at least part of the 1-st display area, the 2-nd display area and the 3-rd display area.

4. The method of claim 1, on condition that information on each of a 1-st main item to an m-th main item, 1-st hierarchy information among at least one 1-st sub item corresponding to the 1-st main item to m-th hierarchy information among at least one m-th sub item corresponding to the m-th main item have been stored and managed in a fixed-value database,
wherein, at the step of (a), spawned location information representing a location where at least part of the 1-st sub item to the m-th sub item is spawned in the field is stored and managed in a variable-value database,
wherein, at the step of (b), in response to determining that the specific sub item is located in the search target area, the game server performs at least part of (i) a process of displaying at least one 1-st location-indicating marker in a 1-st mapping location matching with a direction which the player is currently looking at in the 1-st display area for displaying the azimuth information in a bar form, (ii) a process of displaying at least one 2-nd location-indicating marker in a 2-nd mapping location matching with a location of the specific sub item in the field in the 2-nd display area for displaying the location information in the field; and (iii) a process of displaying at least one 3-rd location-indicating marker in a 3-rd mapping location matching with a location of the specific sub item on the map in the 3-rd display area for displaying the location information on the map.

5. The method of claim 4, wherein, at the step of (b), the game server displays at least part of a specific 1-st location-indicating marker, a specific 2-nd location-indicating marker and a specific 3-rd location-indicating marker corresponding to a selected sub item for upgrading a selected main item among the specific sub item or repairing the selected main item by highlighting the specific 1-st location-indicating marker, the specific 2-nd location-indicating marker and the specific 3-rd location-indicating marker through at least part of the 1-st display area, the 2-nd display area and the 3-rd display area, and wherein the selected main item is an item selected by the player or the game server among the main item.

6. The method of claim 5, wherein, at the step of (b), the game server displays at least part of the specific 1-st location-indicating marker, the specific 2-nd location-indicating marker and the specific 3-rd location-indicating marker by highlighting the specific 1-st location-indicating marker, the specific 2-nd location-indicating marker and the specific 3-rd location-indicating marker through at least part of the 1-st display area, the 2-nd display area and the 3-rd display area, and
wherein the game server (1) detects a specific necessity-degree, corresponding to the selected sub item, defined by a predetermined function having arguments of at least part of (i) information on whether at least one another player located in another player-related reference area determined based on the specific location of the player has selected the selected main item, (ii) information on a distance between the at least one another player and the selected sub item, and (iii) information on a velocity of the at least one another player approaching a location of the selected sub item, and (2) displays at least part of the specific 1-st location-indicating marker, the specific 2-nd location-indicating marker and the specific 3-rd location-indicating marker to correspond to the specific necessity-degree.

7. The method of claim 4, wherein, at the step of (a), in response to acquiring the item search request containing k-th main item information on a k-th main item among the 1-st main item to the m-th main item, k-th sub item information on at least one k-th sub item corresponding to the k-th main item, and the location information of the player in the field and the direction information of the player in the field, the game server (i) transmits a (1_1)-st query for searching a spawned location of at least one (k_1)-st sub item among the k-th sub item by referring to a viewing angle of the player, to thereby acquire a (k_1)-st spawned location information corresponding to the (k_1)-st sub item from the variable-value database, and (ii) determines whether at least one specific (k_1)-st sub item among the (k_1)-st sub item is located within the search target area by referring to the (k_1)-st spawned location information, and
wherein, at the step of (b), in response to detecting that the specific (k_1)-st sub item is located within the search target area determined based on the specific location, the game server displays a (2_1)-st location-indicating marker corresponding to the specific (k_1)-st sub item at a matching spot of the 2-nd display area, wherein the matching spot corresponds to the (k_1)-st spawned location information of the specific (k_1)-st sub item.

8. The method of claim 7, wherein, at the step of (a), the game server (i) further transmits a (1_2)-nd query for searching a spawned location of at least one (k_2)-nd sub item located outside a viewing angle of the player among the k-th sub item to the variable-value database, thereby further acquiring at least one (k_2)-nd spawned location information corresponding to the (k_2)-nd sub item from the variable-value database, and (ii) determines whether at least one specific (k_2)-nd sub item among the (k_2)-nd sub item within the search target area by further referring to the (k_2)-nd spawned location information, and
wherein, at the step of (b), in response to further detecting that the specific (k_2)-nd sub item is located within the search target area determined based on the specific location, the game server further displays a (2_2)-nd location-indicating marker corresponding to the specific (k_2)-nd sub item at a non-matching spot in the 2-nd display area, wherein the non-matching spot corresponds to the (k_2)-nd spawned location information of the specific (k_2)-nd sub item.

9. The method of claim 1, wherein, at the step of (b), the location-indicating marker corresponding to the specific sub item is displayed through at least part of the 1-st display area, the 2-nd display area and the 3-rd display area during a predetermined marker exposure time, wherein the marker exposure time contains a 1-st marker exposure time and a 2-nd marker exposure time according to time-sequential order,
wherein (i) the location-indicating marker is displayed with a fixed 1-st degree of visibility during the 1-st marker exposure time, and (ii) the location-indicating marker is displayed with a variable 2-nd degree of visibility during the 2-nd marker exposure time, and
wherein the variable 2-nd degree of visibility is less than the fixed 1-st degree of visibility.

10. The method of claim 1, wherein, at the step of (a), the sub item information is acquired by performing at least part of (i) a process of determining at least part of a 1-st sub item corresponding to the main item according to a sub item determining algorithm of the game server; and (ii) a process of selecting a 2-nd sub item corresponding to the main item by the player.

11. A game server for providing a battle royale game which allows players to search for sub items used for upgrading or repairing main items, comprising:
at least one memory that stores instructions; and
at least one processor configured to execute the instructions to perform or support another device to perform: (I) a process of, in response to acquiring an item search request containing (i) item information related to at least part of main item information on at least one main item corresponding to a player and sub item information related to at least one sub item corresponding to a player, and (ii) location information of the player in a field, wherein the sub item is an item to be used for upgrading the main item or for repairing the main item, determining or supporting another device to determine whether at least one specific sub item corresponding to the item information is located within a search target area determined based on a specific location corresponding to the location information of the player in the field, by referring to the item search request; and (II) in response to detecting that the specific sub item is located within the search target area determined based on the specific location, displaying or supporting another device to display a location-indicating marker corresponding to the specific sub item through at least part of (i) a 1-st display area for displaying azimuth information, (ii) a 2-nd display area for displaying the location information of the player in the field; and (iii) a 3-rd display area for displaying the location information of the player in the map.

12. The game server of claim 11, wherein, at the process of (I), the processor detects whether the specific sub item corresponding to the item information is located in a 1-st search target area determined based on a 1-st specific location corresponding to the location information of the player in the field by referring to the item search request, and
wherein, at the step of (b), in response to detecting that the specific sub item is not located in the 1-st search target area determined based on the 1-st specific location, the processor determines whether the specific sub item corresponding to the item information is located in a 2-nd search target area determined based on a 2-nd specific location by referring to information on the 2-nd specific location of the player acquired after a time for re-detection has elapsed, and in response to determining that the specific sub item is located in the 2-nd search target area determined based on the 2-nd specific location, displaying the location-indicating marker corresponding to the specific sub item through at least part of the 1-st display area, the 2-nd display area and the 3-rd display area.

13. The game server of claim 11, comprising a process of:
(III) in response to satisfying a specific condition which is one of (i) a 1-st condition that a preset marker exposure time elapsed from a specific timing when the location-indicating marker is displayed through at least part of the 1-st display area, the 2-nd display area and the 3-rd display area, (ii) a 2-nd condition that the specific sub item is acquired by the player in the marker exposure time from the specific timing; and (iii) a 3-rd condition that the specific sub item is acquired by another player in the marker exposure time from the specific timing and that the player moves to an item-adjacent region determined based on a location of the specific sub item in the marker exposure time from the specific timing, the processor blocking the location-indicating marker corresponding to the specific sub item which has been displayed through at least part of the 1-st display area, the 2-nd display area and the 3-rd display area.

14. The game server of claim 11, on condition that information on each of a 1-st main item to an m-th main item, 1-st hierarchy information among at least one 1-st sub item corresponding to the 1-st main item to m-th hierarchy information among at least one m-th sub item corresponding to the m-th main item have been stored and managed in a fixed-value database,
wherein, at the process of (I), spawned location information representing a location where at least part of the 1-st sub item to the m-th sub item is spawned in the field is stored and managed in a variable-value database,
wherein, at the process of (II), in response to determining that the specific sub item is located in the search target area, the processor performs at least part of (i) a process of displaying at least one 1-st location-indicating marker in a 1-st mapping location matching with a direction which the player is currently looking at in the 1-st display area for displaying the azimuth information in a bar form, (ii) a process of displaying at least one 2-nd location-indicating marker in a 2-nd mapping location matching with a location of the specific sub item in the field in the 2-nd display area for displaying the location information in the field; and (iii) a process of displaying at least one 3-rd location-indicating marker in a 3-rd mapping location matching with a location of the specific sub item on the map in the 3-rd display area for displaying the location information on the map.

15. The game server of claim 14, wherein, at the process of (II), the processor displays at least part of a specific 1-st location-indicating marker, a specific 2-nd location-indicating marker and a specific 3-rd location-indicating marker corresponding to a selected sub item for upgrading a selected main item among the specific sub item or repairing the selected main item by highlighting the specific 1-st location-indicating marker, the specific 2-nd location-indicating marker and the specific 3-rd location-indicating marker through at least part of the 1-st display area, the 2-nd display area and the 3-rd display area, and wherein the selected main item is an item selected by the player or the game server among the main item.

16. The game server of claim 15, wherein, at the process of (II), the processor displays at least part of the specific 1-st location-indicating marker, the specific 2-nd location-indicating marker and the specific 3-rd location-indicating marker by highlighting the specific 1-st location-indicating marker, the specific 2-nd location-indicating marker and the specific 3-rd location-indicating marker through at least part of the 1-st display area, the 2-nd display area and the 3-rd display area, and
wherein the processor (1) detects a specific necessity-degree, corresponding to the selected sub item, defined by a predetermined function having arguments of at least part of (i) information on whether at least one another player located in another player-related reference area determined based on the specific location of the player has selected the selected main item, (ii) information on a distance between the at least one another player and the selected sub item, and (iii) information on a velocity of the at least one another player approaching a location of the selected sub item, and (2) displays at least part of the specific 1-st location-indicating marker, the specific 2-nd location-indicating marker and the specific 3-rd location-indicating marker to correspond to the specific necessity-degree.

17. The game server of claim 15, wherein, at the process of (II), in response to acquiring the item search request containing k-th main item information on a k-th main item among the 1-st main item to the m-th main item, k-th sub item information on at least one k-th sub item corresponding to the k-th main item, and the location information of the player in the field and the direction information of the player in the field, the processor (i) transmits a (1_1)-st query for searching a spawned location of at least one (k_1)-st sub item among the k-th sub item by referring to a viewing angle of the player, to thereby acquire a (k_1)-st spawned location information corresponding to the (k_1)-st sub item from the variable-value database, and (ii) determines whether at least one specific (k_1)-st sub item among the (k_1)-st sub item is located within the search target area by referring to the (k_1)-st spawned location information, and
wherein, at the process of (II), in response to detecting that the specific (k_1)-st sub item is located within the search target area determined based on the specific location, the processor displays a (2_1)-st location-indicating marker corresponding to the specific (k_1)-st sub item at a matching spot of the 2-nd display area, wherein the matching spot corresponds to the (k_1)-st spawned location information of the specific (k_1)-st sub item.

18. The game server of claim 17, wherein, at the step of (I), the processor (i) further transmits a (1_2)-nd query for searching a spawned location of at least one (k_2)-nd sub item located outside a viewing angle of the player among the k-th sub item to the variable-value database, thereby further acquiring at least one (k_2)-nd spawned location information corresponding to the (k_2)-nd sub item from the variable-value database, and (ii) determines whether at least one specific (k_2)-nd sub item among the (k_2)-nd sub item within the search target area by further referring to the (k_2)-nd spawned location information, and
wherein, at the process of (II), in response to further detecting that the specific (k_2)-nd sub item is located within the search target area determined based on the specific location, the processor further displays a (2_2)-nd location-indicating marker corresponding to the specific (k_2)-nd sub item at a non-matching spot in the 2-nd display area, wherein the non-matching spot corresponds to the (k_2)-nd spawned location information of the specific (k_2)-nd sub item.

19. The game server of claim 11, wherein, at the process of (II), the location-indicating marker corresponding to the specific sub item is displayed through at least part of the 1-st display area, the 2-nd display area and the 3-rd display area during a predetermined marker exposure time, wherein the marker exposure time contains a 1-st marker exposure time and a 2-nd marker exposure time according to time-sequential order,
wherein (i) the location-indicating marker is displayed with a fixed 1-st degree of visibility during the 1-st marker exposure time, and (ii) the location-indicating marker is displayed with a variable 2-nd degree of visibility during the 2-nd marker exposure time, and
wherein the variable 2-nd degree of visibility is less than the fixed 1-st degree of visibility.

20. The game server of claim 11, wherein, at the process of (I), the sub item information is acquired by performing at least part of (i) a process of determining at least part of a 1-st sub item corresponding to the main item according to a sub item determining algorithm of the game server; and (ii) a process of selecting a 2-nd sub item corresponding to the main item by the player.
